(19) United States
(12) Patent Application Publication
(10) Pub. No.: US 2006/0231553 A1
(43) Pub. Date: Oct. 19, 2006

(54) Retractable canopy range vent hood mounted below over-the-range microwave ovens

(76) Inventor: Cyrus Gerami, Chicago, IL (US)

Correspondence Address: JOAN I. NOREK,;THE LAW OFFICE OF JOAN I. NOREK, 19 N. GREEN STREET, CHICAGO, IL, 60607, US

(21) Appl. No.: 11/377,738

(22) Filed: Mar. 16, 2006

Related U.S. Application Data
(60) Provisional application No. 60/672,006, filed on Apr. 18, 2005.

(51) Int. Cl. H05B 6/64

(52) U.S. Cl. 219/757

(57) ABSTRACT

A canopy vent hood, particularly for mounting below an over-the-range microwave oven, has a substantially flat first side panel, a substantially flat second side panel and a triangulate-profiled nose element. The first and second side panels are spaced apart, and the nose element is translatable between a first position jutting out and downwardly over the range top from between the first and second side panels, to a second position jutting out over the range top from between the first and second side panels, to a third position completely retracted between the first and second side panels. The first and second side panels each have a substantially straight-vertical first front edge, and these edges lie substantially within and determine a vertical plane. The nose member is substantially disposed forward of the vertical plane in the first position and substantially disposed behind the vertical plane in the third position. The nose element can be a substantially see-through nose element. A method of preparing food and venting fumes, heat, vapor and other emissions in the vicinity of the range top employs the canopy vent hood mounted below an over-the-range microwave oven. The nose member is translated to the first position during cooking, and up to the second position while cooking if arm reach is needed. The third position is used after the cooking process, storing the nose member out of the way.

### CROSS-REFERENCE TO RELATED APPLICATIONS

The present application claims filing date priority under 35 U.S.C. 119 based on U.S. provisional application Ser. No. 60/672,006, filed Apr. 18, 2005. The entire disclosure of U.S. provisional application Ser. No. 60/672,006 is incorporated herein by reference.

### BACKGROUND OF THE INVENTION

The present invention relates to devices and methods for venting fumes and other emissions in the vicinity of a kitchen range. In particular, the present invention relates to devices and methods for venting fumes, heat, vapor and other emissions in the vicinity of a kitchen range positioned below an over-the-range microwave oven

Over-the-range microwave ovens have become common, or at least not uncommon, household appliances. They are found in apartments, condominium units, single-family homes, and other residential facilities, including group-living facilities such as nursing homes and the like. They are also found in nonresidential facilities, such as sport clubs, small eateries and the like.

Over-the-range microwave ovens are increasing in popularity for several reasons. Countertop microwave ovens require countertop space. Many households have little enough countertop work space without a bulky microwave oven occupying a significant amount of space. Further, the countertop space that can be allotted to a microwave oven is often inconveniently located, particularly when a meal or the like is being prepared both on the range and in the microwave oven. In addition, a microwave oven is a heavy, bulky appliance that cannot be readily shifted from one position to another, and therefore it cannot easily stored away when not in use nor moved over next to the range when desired.

Over-the-range microwave ovens solve the countertop space and inconvenient location problems. Over-the-range ovens take up no countertop space, and are at hand when both the stove range and the microwave oven are being used at the same time.

One problem introduced by over-the-range microwave ovens is their displacement of conventional over-the-range vent hoods. Most over-the-counter microwave ovens are equipped with integral filters and exhaust fans as a substitute for conventional range hoods. These substitutes are, however, routinely inadequate to capture the fumes, heat and other routine range top emissions. The air around a heating source, and around anything being heated thereby, itself is heated. When the temperature of the air rises, it expands upwardly and outwardly. The expanding air of course carries the range top emissions along with it as it moves outward.

The outwardly expanding air works against the built-in filters and fans of an over-the-range microwave oven. Little of the emissions other than those directly rising with the upwardly expanding portion of air are caught. The remainder of the emissions spread through the kitchen and beyond to other living areas.

Stove top emissions routinely include odors and grease laden vapors that are absorbed by, or settle onto, surfaces. Furniture, carpets and clothing can readily become contaminated with the smell and the grease particles. Walls and other surfaces become soiled and discolored. When stove top emissions are circulated in the air, they increase the frequency and thoroughness of household cleaning that is required. In addition, these conditions contribute to poor indoor air quality, which in turn leads to occupant discomfort and aggravation of allergies.

An increase in energy consumption for indoor heating and cooling purposes is a major negative consequence of such under-controlled stove-top emissions. Windows and doors are typically opened more frequently, and kept open longer, to circulate fresh air and replace stale and unhealthy indoor air. Whenever a window or the like is opened while the heating or air conditioning system is operating, the incoming outdoor air places additional burdens on the system.

The negative impacts of open windows due to under-controlled stove-top emissions are greater in multi-unit high rise buildings, such as high-rise apartment and condominium buildings. When more than the occasional window is opened, the balance in the air distribution system in the entire building is disturbed. During the indoor heating season, open windows create cold draft at the lower floors due to stack effect. This is a phenomenon attributed to the buoyancy of warm air.

### SUMMARY OF THE INVENTION

The present invention provides a canopy vent hood for installation beneath an over-the-range microwave oven.

The present invention also provides a cooking station which includes a range top, an over-the-range microwave oven and a canopy vent hood mounted beneath the microwave oven.

The present invention also provides a method of preparing food employing a cooking station which includes a range top, an over-the-range microwave oven and a canopy vent hood mounted beneath the microwave oven.

### BRIEF DESCRIPTION OF THE SEVERAL VIEWS OF THE DRAWINGS

FIG. 1 is a perspective view of a canopy vent hood of the present invention shown assembled but not mounted with the canopy nose section extended.

FIG. 2 is a side view of the canopy vent hood of FIG. 1.

FIG. 3 is a side view of the canopy vent hood of FIG. 1 with internal components shown in phantom.

FIG. 4 is a side view of the canopy vent hood of FIG. 1 shown with canopy nose section retracted.

FIG. 5 is a side view of the canopy vent hood of FIG. 1 shown with canopy nose section partially extended and with internal components shown in phantom.

FIG. 6 is a partially diagrammatic side view of a prior art range top and over-the-range microwave oven.

FIG. 7 is a partially diagrammatic side view of the canopy vent hood of FIG. 1 shown mounted beneath the over-the-range microwave oven, shown with the nose member retracted.

FIG. 8 is a partially diagrammatic side view of the canopy vent hood of FIG. 1, shown mounted as shown in FIG. 7, shown with the nose member partially extended.

FIG. 9 is a partially diagrammatic side view of the canopy vent hood of FIG. 1, shown mounted as shown in FIG. 7, shown with the nose member fully extended.

FIG. 10 is a perspective view of a canopy vent hood of the present invention, shown mounted below a microwave oven above a range top.

FIG. 11 is perspective view of the canopy vent hood of FIG. 10, shown alone with the nose member fully retracted.

FIG. 12 is perspective view of the canopy vent hood of FIG. 10, shown alone with the nose member partially extended.

FIG. 13 is perspective view of the canopy vent hood of FIG. 10, shown alone with the nose member fully extended.

FIG. 14 is perspective view of the canopy vent hood of the present invention.

FIG. 15 is partially diagrammatic, perspective view of the canopy vent hood of FIG. 14, with a side panel and back panel removed to expose for illustration purposes the mounting bracket at the rear.

### DETAILED DESCRIPTION OF THE INVENTION

The embodiment of the present invention shown in FIG. 1 through FIG. 5 is a canopy vent hood 10 shown unmounted. The canopy vent hood 10 has a first side panel 12 and a second side panel 14 which are spaced-apart and opposite each other.

The first side panel 12 has a front edge 16, a rear edge 18, a bottom edge 20 and a top edge 22. As shown and in preferred embodiment, the front edge 16 and the rear edge 18 are substantially parallel. As shown and in preferred embodiment, the bottom edge 20 and the top edge 22 are substantially parallel. As shown and in preferred embodiment, the front edge 16 and the rear edge 18 each run substantially at right angles to the bottom edge 20 and the top edge 22.

The second side panel 14 has a front edge (not shown), a rear edge 26, a bottom edge 28 and a top edge 30. As shown and in preferred embodiment, the front edge and the rear edge 26 are substantially parallel. As shown and in preferred embodiment, the bottom edge 28 and the top edge 30 are substantially parallel. As shown and in preferred embodiment, the front edge and the rear edge each run substantially at right angles to the bottom edge 28 and the top edge 30. The second side panel 14 is a mirror image of the first side panel, and therefore further description and illustration of its features are neither required nor provided herein.

The first side panel 12 and second side panel 14 as shown and in preferred embodiment each have a substantially rectangular profile, and each has a length that is greater than its height.

The canopy vent hood 10 as shown and in some embodiments also has a mounting-bracket rear panel 32 for attachment of the hood 10 to the wall. The rear panel 32 of the canopy vent hood 10 shown in FIG. 1 to FIG. 5 bridges the first side panel 12 and the second side panel 14 from the rear edge 18 to the rear edge 26. The rear panel 32 has a first side edge (not shown) and a second side edge 36. As shown and in preferred embodiment, the first side edge of the rear panel 32 meets the rear edge 18 of the first side panel 12, and the rear panel 32 is affixed to the first side panel 12 along the juncture of its first side edge (not shown) and rear edge 18. As shown and in preferred embodiment, the second side edge 36 of the rear panel 32 meets the rear edge 26 of the second side panel 14, and the rear panel 32 is affixed to the second side panel 14 along the juncture of side edge 36 and rear edge 26. The first side edge (not shown) is a mirror image of the second side edge 36, and therefore further description and illustration of its features are neither required nor provided herein.

The rear panel 32 as shown and in preferred embodiments has a top edge 38 and a bottom edge (not shown). As shown and in preferred embodiment, the first side edge (not shown) and the second side edge 36 each run at substantially right angles to the top edge 38 and bottom edge 40. As shown and in preferred embodiments, the rear panel 32 has a substantially rectangular profile. Its length is greater than its height, which height is substantially the same as the heights of the first side panel 12 and the second side panel 14. The rear panel includes at least one bracket 33, shown in phantom, for mounting to a wall, which is described further below. The bottom edge (not shown) is a mirror image of the top edge 38, and therefore further description and illustration of its features are neither required nor provided herein.

The canopy vent hood 10 has a nose member 42. The nose member 42 has a front panel 44 which bridges a first endplate 46 and a second end plate 48. In preferred embodiment and as shown, the front panel 44 is a see-through vision panel made of regular or tempered glass or other high-temperature resistant material such as high-temperature resistant clear plastics. As shown and in some embodiments, the front panel 44 has substantially parallel top and bottom edges that are each separately sheathed in respectively a top edging 50 and a bottom edging 52. The bottom edging 52 as shown and in preferred embodiment has a wider center grip section 54 which provides a convenient fingertip grip.

As shown and in preferred embodiments, both the first end plate 46 and second end plate 48 have substantially the same six-sided polygonal, or hexagonal, profile. The first end plate 46 has, in circumferential order, a front edge 56, a top edge 58, a rear edge 60, a base edge 62, a lower edge 64 and a tip edge 65. Likewise the second end plate 48 has, in circumferential order, a front edge 66, a top edge 68, a rear edge 70, a base edge 72, a lower edge 74 and a tip edge 75. The front panel 44 is affixed on one side to the front edge 56 of the first end plate 46, and on the other side to the front edge 66 of the second end plate 48.

An outwardly projecting first knob 76 has a knob member 77 and a stem (not shown). The first knob 76 is affixed at its stem to the first end plate 46 close to the junction of the lower edge 64 and the base edge 62. An opposite outwardly projecting second knob 78 has a knob member 79 and a stem (not shown). The second knob 78 is affixed to the second end plate 48 close to the junction of the lower edge 74 and the base edge 72. The first and second knobs 76, 78 are swivel knobs which are stationarily affixed relative respectively the first end plate 46 and the second end plate 48.

The first side panel 12 has a first slot 80 that runs parallel to, and a short distance above, its first bottom edge 20, starting a short distance back from its first front edge 16 and continuing back to a point short of halfway. The second side panel 14 has a second slot 82 that runs parallel to, and a short distance above, its second bottom edge 28, starting a short distance back from its front edge (not shown) and continuing back to a point short of halfway. As shown in FIG. 1 through FIG. 5, the first knob 76 is seated in the first slot 80 with its knob member 77 positioned on the outer side. Likewise, the second knob 78 is seated in the second slot 82 with its knob member 79 positioned on the opposite outer side of the canopy vent hood 10. Knob members 77, 79 are both sufficiently large that they cannot pass through the respective first slot 80 and second slot 82. The first and second knobs 76, 78 are detents that keep the nose member 42 movably attached to the side panels 12, 14.

The first side panel 12 has inner ledges 84, 85 along respectively its bottom and top edges 20, 22 that run substantially the entire length of the first side panel 12, from its front edge 16 to its rear edge 18. The second side panel 14 has inner ledges 86, 87 along respectively its bottom and top edges 28, 30 that run substantially the entire length of the second side panel 14, from its front edge (not shown) to its rear edge 26. Ledge 84 and ledge 86 therefore jut out inwardly towards each other, and ledge 85 and ledge 87 likewise jut out inwardly towards each other.

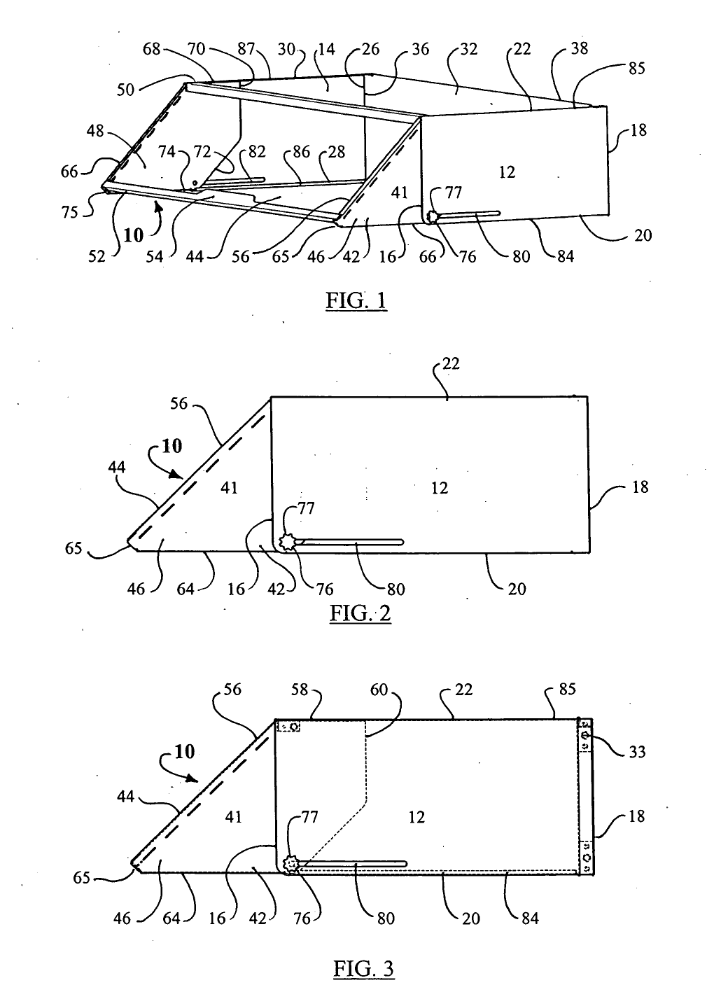

As seen in FIG. 1, FIG. 2 and FIG. 3, when the nose member 42 is in its fully extended or projecting position, the front panel 44 is positioned jutting out from the side panels 12, 14. The front panel 44 slants down and outward at about a 45 degree angle. The top edges 58, 68 of the first and second end plates 46, 48 meet, and bear against, the upper ledges 85, 87 of the first and second side panels 12, 14. The top edges 58, 68 of the first and second end plates 46, 48 are in substantial co-alignment with respectively the top edges 22, 30 of the first and second side panels 12, 14 of the canopy vent hood 10. The base edges 62, 72 of the first and second end plates 46, 48 run substantially parallel to the front edges 16 (front edge of the second side panel not shown) of the first and second side panels 12, 14 of the canopy vent hood 10. The lower edges 64, 74 of the first and second end plates 46, 48 are in forward-displaced co-alignment with respectively the bottom edges 20, 28 of the first and second side panels 12, 14, and are partially seated on respectively the first ledge 84 and the second ledge 86. The first knob 76 and the second knob 78 are positioned substantially forward most in the respective slots 80, 82.

Also as seen in FIG. 1, FIG. 2 and FIG. 3, when the nose member 42 is in its fully extended or projecting position, a nose element 41 is determined. The nose element 41 is that portion of the nose member 42 that is disposed outside of the vertical plane determined by the front edges 16, (not shown) of the first and second side panels 12, 14. Such nose element 41 in the embodiment shown includes the front panel 44 and the triangulate portions of the first and second end plates 46, 48 that are forward of the vertical plane when the nose member 42 is in its fully extended or projecting position.

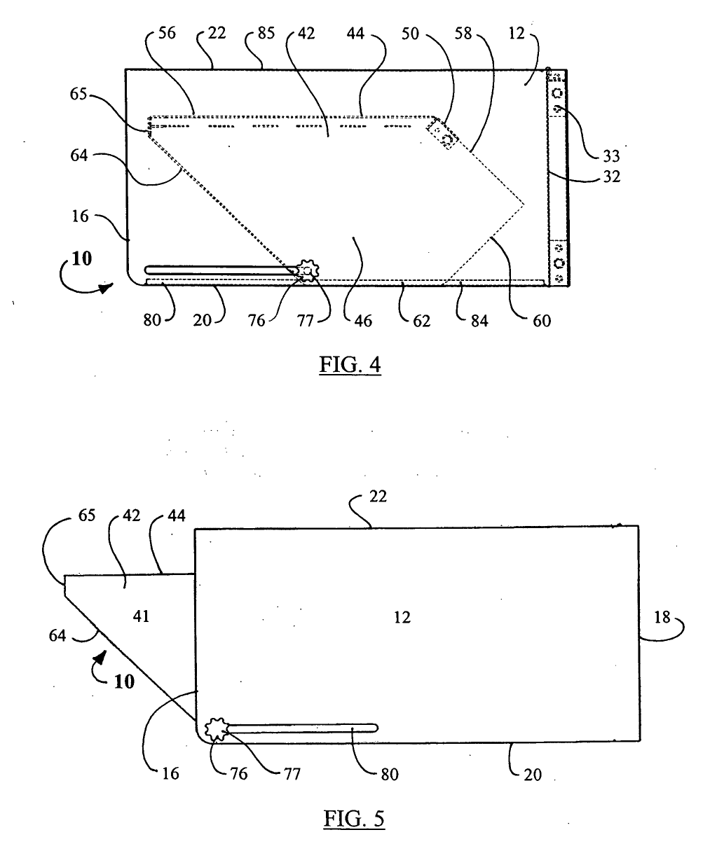

In FIG. 4 the nose member 42 is shown in its fully retracted position. The nose member 42 is wholly retracted into the space between the side panels 12, 14. The front panel 44 is positioned horizontally. The top edges 58, 68 of the first and second end plates 46, 48 slant downwardly and rearward towards the rear panel 32, although they remain spaced apart from the rear panel 32. The base edges 62, 72 of the first and second end plates 46, 48 are seated respectively on the first ledge 84 and the second ledge 86 of the first side panel 12 and the second side panel 14. The first knob 76 and the second knob 78 are positioned rearmost in the respective slots 80, 82. The translation of the nose member 42 from its extended position to its fully retracted position can be accomplished by sliding the knobs 76,78 rearward in the slots 80, 82 while turning the knobs 76, 78 in a top-to-rear direction. Alternatively, the front panel 44 can be grasped, preferably with both hands and preferably at or about the wide center section 54, and moved up and back, which action will slide the knobs 76,78 rearward in the slots 80, 82 and turn the knobs 76, 78 in a top-to-rear direction.

In FIG. 5 the nose member 42 is shown in its partially retracted position, which can be considered a raised position. The nose member 42 is forward of its wholly retracted position but not rotated down to its fully extended position. The front panel 44 is positioned horizontally. The top edges 58, 68 of the first and second end plates 46, 48 slant downwardly and rearward towards the rear panel 32, although they remain spaced apart from the rear panel 32. The base edges 62, 72 of the first and second end plates 46, 48 are seated respectively on the ledges 84, 86 of respectively the first side panel 12 and the second side panel 14. The first knob 76 and the second knob 78 are positioned forward-most in the respective slots 80, 82. The translation of the nose member 42 from its fully extended position to its partially extended or raised position seen in FIG. 5 can be accomplished by turning the knobs 76, 78 in a top-to-rear direction without sliding the knobs 76,78 rearward in the slots 80, 82. Alternatively, the front panel 44 can be grasped, preferably with both hands and preferably at or about the wide center section 54, and moved up, but not back, which action will turn the knobs 76, 78 in a top-to-rear direction without sliding the knobs 76,78 rearward in the slots 80, 82.

It is noted here, and discussed further below, that a canopy vent hood of the present invention, such as the canopy vent hood 10 described above, is preferably independent of any microwave oven under which it is, or is to be, mounted. None of the parts or components of the canopy vent hood 10 touch the microwave oven at any time. Having any part of a canopy vent hood bear against the microwave oven, or mounting a canopy vent hood of the present invention to the bottom of a microwave oven, might void a warranty on the microwave oven. Further, any such embodiments might be limited to specific makes and models of microwave ovens. The canopy vent hood of the present invention is preferably not limited to specific makes and models of microwave ovens, and can instead by installed under a variety of microwave ovens, and installed at the same time as the microwave oven or installed under existing over-the-range microwave ovens. Nonetheless, microwave-bottom-mounted canopy vent hoods, or hoods with one or more components coming into contact with a microwave oven mounted above, are not excluded from the broader embodiments of the present invention.

Further, wall mounting of a canopy vent hood of the present invention, such as the canopy vent hood 10 described above, with brackets or other mechanical fasteners is sufficient to hold the canopy vent hood up close to the bottom of an over-the-range microwave oven. A gap of for instance about an eighth of an inch between the top edges of the canopy vent hood and the bottom of the microwave oven will be sufficiently close to avoid impairing its function without making actual contact with the microwave oven.

The canopy vent hood 10 as shown in FIG. 1 to FIG. 5, and in some preferred embodiments of the present invention, is about thirty inches wide, about seven inches high, about fourteen inches deep when the nose member 42 is fully retracted, and about twenty-one inches deep when the nose member 42 is fully extended. The width and depth of a canopy vent hood of the present invention preferably should sufficiently mirror the width and depth of over-the-range microwave ovens, which currently are standardized, to the extent necessary to realize at least some, and not necessarily all, of the advantages described herein. A height of about seven inches has been found to ergonomically advantageous, and a height within the range of from about four inches to about eight or nine inches are sufficiently useful and likely to be sufficiently effective. The height of canopy vent hood of the present invention above the range top will of course depend on the height at which the microwave oven is, or will be, mounted. Currently microwave oven manufacturers are recommending that their microwave ovens be mounted sufficiently high so that there is a space of at least about sixteen inches between the range top and the bottom of the microwave oven when mounted.

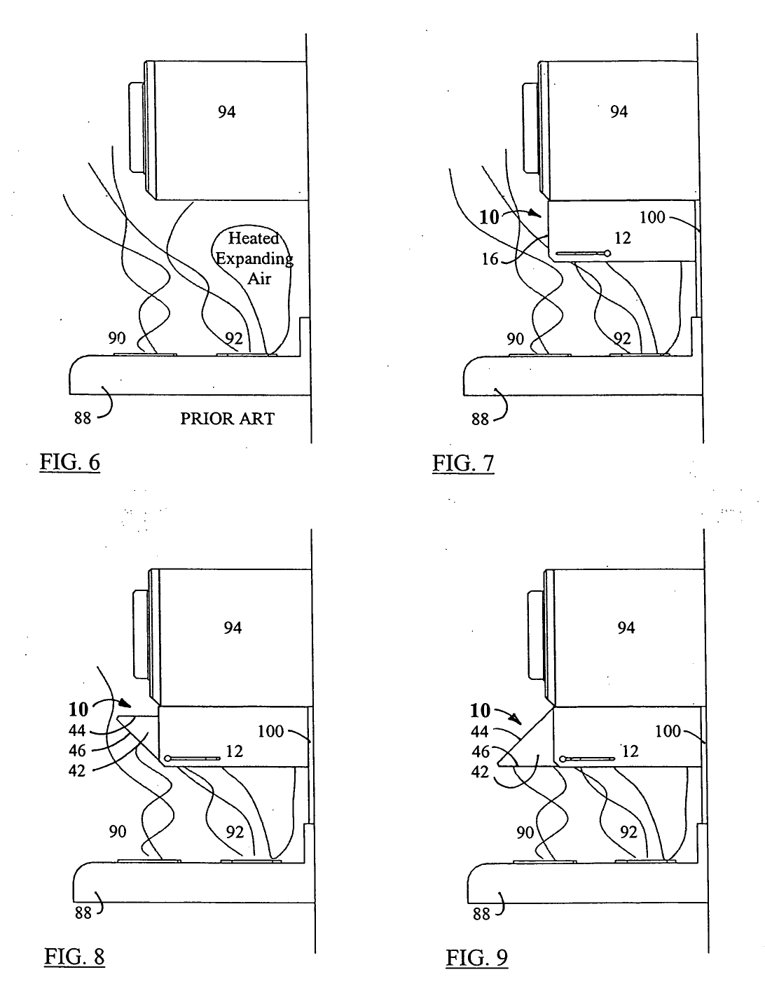

Referring now to FIG. 6 through FIG. 9, there is shown a conventional range top 88 with a front burner 90 and a back burner 92, and a microwave oven 94 mounted above the range top 88 in the conventional over-the-range mounting position. As seen in FIG. 6 through FIG. 9, the microwave oven 94 is not mounted very high from the range top 88. Such rather low mounting position is required to allow someone working with both the range top 88 and the microwave oven 94 to easily reach up to the microwave oven 94. The person cooking must be able to not only readily open and close the microwave oven 94 when putting in and removing dishes, but also operate the front panel controls (not shown) of the microwave oven 94. Such accessibility needs results in the placement of the microwave oven 94 relatively close to the range top 88. In addition, wall-mounting of the microwave oven 94, as seen in FIG. 6 through FIG. 9, results in positioning the backburner 92 completely beneath the microwave oven 94, and the front burner 90 at least partially under the microwave oven 94. It is to be understood that most range tops will have four burners, two of which are back burners and two of which are front burners. Only one set comprised of the front burner 90 and the back burner 92 are shown here for simplicity. Also for simplicity only the range top 88 is shown here, and such a range top can be the top of a conventional stove, or an electric range top built into a counter, and the like.

In FIG. 6 there is shown the prior art arrangement of the range top 88 placed against the wall 98 with the microwave oven 94 mounted above it on the wall 98. Both the front burner 90 and back burner 92 are on. The heat generated by particularly the back burner 92 heats the air above and behind the back burner 92, and that air expands. Since the wall 98 and the bottom of the microwave oven 94 limit the air expansion to the rear and upwardly, the air expansion is mainly forward and sideways. The expanding air at the back will push the fumes from anything cooking (not shown) on the back burner 92 forward, which in turn pushes the fumes from anything cooking (not shown) on the front burner 90 forward. The built-in ventilation system (not shown) on the bottom of the microwave oven 94 will routinely fail to capture any of the fumes from the front burner 90, and commonly will fail to wholly capture even the fumes off the back burner 92.

In FIG. 7 through 9 there is shown the same arrangement of range top 88 and microwave oven 94 with the further inclusion of the canopy vent hood 10 shown in FIG. 1 through 5. Also shown in FIG. 7 through 9 is an optional backsplash member 100, which backsplash member 100 could of course be formed either separate or integral with the rear panel 32 of the canopy vent hood 10.

As shown in FIG. 7 through FIG. 9, the canopy vent hood 10 is mounted close to the bottom of the microwave oven 94. A gap of about one-eighth of an inch, or within the range of from about one-sixteenth to about three-eighths of an inch between a canopy vent hood of the present invention, is believed sufficient not to void any warranty on the microwave oven while maintaining a sufficient proximity or nearness between the canopy vent hood and the bottom of the microwave oven for effectiveness. When warranties and like issues are not present, it is believed that a canopy vent hood of the present invention can be mounted substantially flush to the bottom of an over-the-range microwave oven. Wall mounting the canopy vent hood 10 with brackets or other mechanical fasteners is sufficient to hold the canopy vent hood 10 up sufficiently close to the bottom of the microwave oven 94 as shown. Nothing in the present invention, however, excludes mounting directly to the bottom of an over-the-range microwave oven when circumstances and warranties permit such mounting, which can be readily done using well known mechanical fasteners and the like.

As shown in FIG. 7, the side panels 12, 14 will assist capturing the fumes from the back burner 92 even when the nose member 42 is in the fully retracted position. The fully retracted position is preferably not used when cooking on the stovetop 88. It is noted again, however, as seen best in FIG. 4, that when the nose member 42 is fully retracted, the front panel 44 is positioned horizontally, and therefore essentially below and parallel to the microwave bottom (not shown in FIG. 4). As noted elsewhere, the hood 10 is about seven inches high. There is, as shown, a gap of about two inches between the horizontally-positioned front panel 44 and the edges of the canopy vent hood 10. Therefore the front panel 44 is spaced apart from the bottom of a microwave oven at least about two inches, and there is a gap between the rearward edge of the front panel 44 and the rear panel 32 of about five or six inches. There would be no blocking of a light on the bottom of a microwave oven because the front panel 44 is transparent, and little interference with an exhaust fan or filter on the bottom of a microwave oven even if cooking is started, or continued, with the canopy vent hood 10 in its fully retracted position. The ease at which the nose member 42 can be extended, however, substantially eliminates any need or motivation for cooking with the canopy vent hood 10 in its fully retracted position.

As shown in FIG. 8, in which the nose member 42 in a raised position, namely with the nose member 42 fully forward while the front panel 44 remains horizontal, fumes from both the back burner 92 and front burner 90 are drawn into canopy vent hood 10. Such a raised or midway position of the nose member 42 permits the back burner 92 to be more easily reached for cleaning or other purposes.

As shown in FIG. 9, with the nose member 42 in the fully extended position, the forward reach of the nose member 42 extends beyond the front burner 90. The fumes from both the front burner 90 and back burner 92 are fully captured by the canopy vent hood 10. Further, the entire top of the range top 88 can easily be seen through the transparent front panel 44. In addition, the person cooking can raise the front panel 44 to the raised position to rotate the front panel 44 up and out of the way when convenient. If the front panel 44 is rotated back into place within a short time thereafter, little efficacy of the canopy vent hood 10 is lost during the interval.

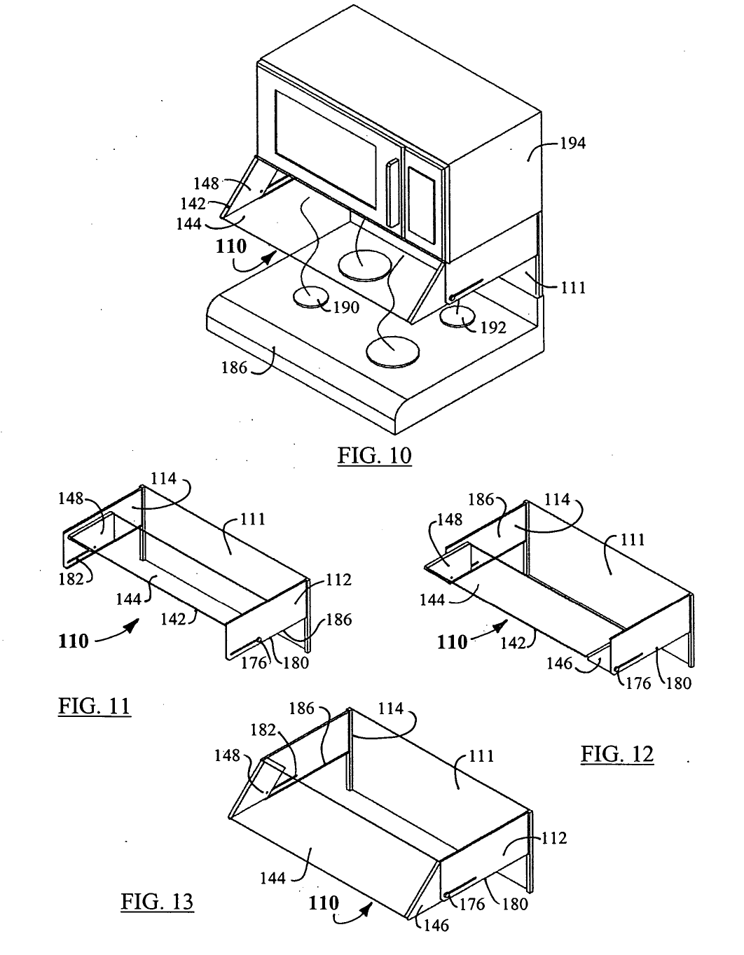

The embodiment of the present invention shown in FIG. 10 through FIG. 13 is a canopy vent hood 110 of the present invention which includes an integral backsplash member 111. The canopy vent hood 110 has a rectangular first side panel 112 and a rectangular second side panel 114 which are spaced-apart and opposite each other, and each are mounted on, and project outwardly from, the backsplash member 111. The backsplash member 111 not only avoids soiling of wall surfaces, but also protects the wall from splashes of hot fluids, such as water and oil, during cooking, particularly frying, which is a safety feature.

The canopy vent hood 110 has a nose member 142 comprised of a transparent front panel 144 mounted on, and positioned between, a first end plate 146 and a second end plate 148. The nose member 142 is moveable between a first retracted position shown in FIG. 11, to a second partially extended position shown in FIG. 12, to a third fully extended position shown in FIG. 13. The configuration, mounting and movement of the nose member 142 are the same as described above regarding nose member 42 of FIG. 1 through FIG. 9, and the description need not be, and is not, repeated here.

The canopy vent hood 110 also has outwardly projecting knobs, such as the knob 176 shown, that are seated in, and ride along slots 180, 182 in respectively the first and second panels 112, 114.

The side panels 112, 114 both have inner ledges, such as the inner ledge 186 shown, on which the end plates 146, 148 ride. The ledges act as a stop member and support member for the end plates 146, 148 in the same manner as described above regarding the ledges 84, 86 of the canopy vent hood 10 of FIG. 1 to FIG. 9.

As seen in FIG. 10, when the nose member 142 is in its extended or projecting position, the front panel 144 is positioned jutting out from the side panels 112, 114. The front panel 144 slants down and outward at about a 45 degree angle over a range top 188 with front burners 190 and back burners 192. The canopy vent hood 110 is mounted beneath a microwave oven 194 which is mounted above the range top 188 in the conventional over-the-range mounting position. As seen in FIG. 10, the microwave oven 194 is mounted within easy reach of a person working at the range top 188, and the back burners 192 are visible through the transparent front panel 144 of the extended nose member 142. A person cooking can easily move the nose member 142 into the partially extended position, or even into the fully retracted position when reaching up to the microwave oven 194 or reaching back to the back burners 192, as more fully described regarding the canopy vent hood 10 shown and described above.

As shown in FIG. 10, with the nose member 142 in the fully extended position, the forward reach of the nose member 142 extends beyond the front burners 190. The fumes from both the front burners 190 and back burners 192 are fully captured by the canopy vent hood 110. Further, the entire top of the range top 188 can easily be seen through the transparent front panel 144.

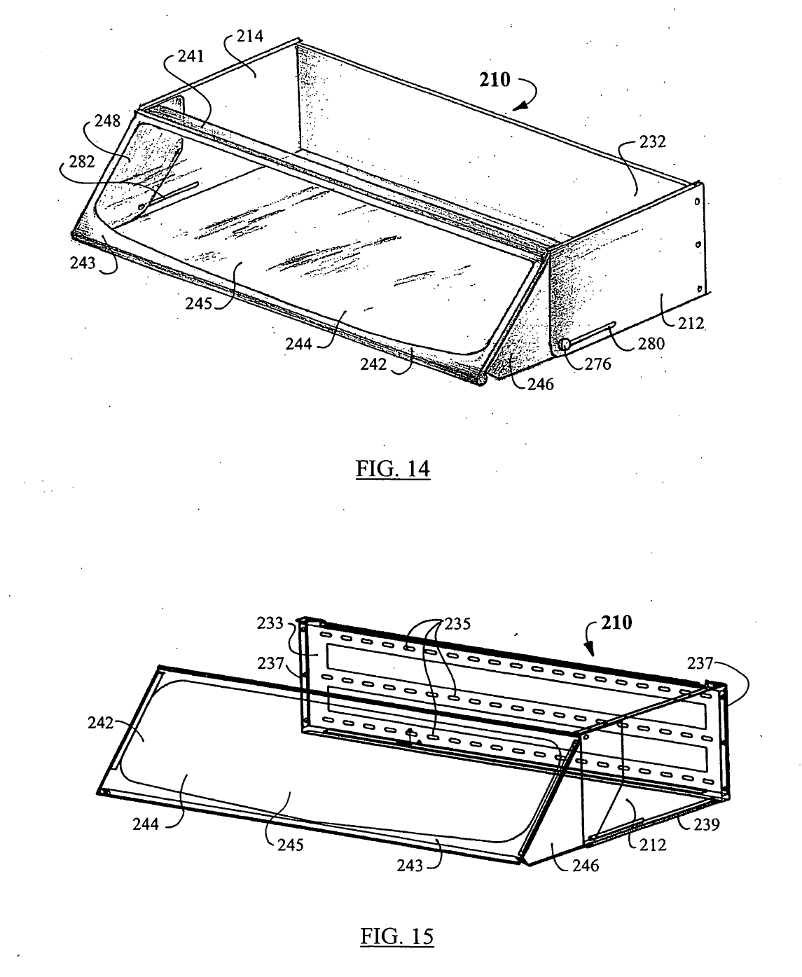

The embodiment of the present invention shown in FIG. 14 is a canopy vent hood 210 shown unmounted and then and FIG. 15 diagrammatically in partially disassembled state to better illustrate the mounting apparatus. Because the embodiment shown in FIG. 14 and FIG. 15 are in many respects the same as discussed above, descriptions of details are generally not required and not provided.

The canopy vent hood 210 has a first side panel 212 and a second side panel 214 (not shown in FIG. 15) which are spaced-apart and opposite each other. The first and second side panels 212, 214 have a substantially rectangular profile, and each has a length that is greater than its height.

The canopy vent hood 210 has a nose member 242. The nose member 242 has a front panel 244 which bridges a first endplate 246 and a second end plate 248 (not shown in FIG. 15). In this preferred embodiment as shown, the front panel 244 is comprised of an open-centered frame 243 within which is mounted a transparent member 245. The open-centered frame 243 and transparent member 245 mounted therein in combination provide a front panel 244 which is a see-through vision panel because it is transparent except where the frame 243 covers the transparent member 245 around the edges. As shown and in some preferred embodiments, the frame 243 is formed with a narrow open top or rear end through which the transparent member 245 is slid during assembly. A retention bar 241 immediately behind the transparent member 245 when seated within the frame 245 prevents slippage of the transparent member 245 in the frame 243 after assembly. The exposed surface of the frame 243 provides a convenient hand or fingertip grip area, particularly to either side of front center for the handling of the nose member 242 with both hands.

The canopy vent hood 210 as shown has a rear panel 232 (not shown in FIG. 15) positioned in front of a mounting bracket 233 (not shown in FIG. 14). The mounting bracket 233 provides the structure for attachment of the hood 210 to the wall. As shown, the mounting bracket 233 includes a single piece panel with three horizontal spaced-apart rows of mounting apertures 235 (top, center and bottom) flanked by forward-jutting side ledges 237 and a forward-jutting lower ledge 239. In the mounting process, the mounting bracket 233 can be separated from the other components of the canopy vent hood 210, positioned against a wall at the desired spot, and securely mounted to such a wall using mechanical fasteners, such as headed wood screws, bolts and the like, through a plurality of the apertures 235, and then the remainder of the canopy vent hood components are placed, with the rear panel 232, plus the first and second side panels 212, 214, being affixed and secured to the mounting bracket 233 with mechanical fasteners. This or other mounting designs can be employed for other embodiments of the invention.

As shown and in preferred embodiments, the canopy vent hood 210 has a first end plate 246 and second end plate 248 have substantially the same five-sided polygonal, or pentagonal, profile. The fame 243 of the front panel 244 is affixed to the first end plate 246 and second end plate 248, bridging these elements.

Also shown is an outwardly projecting first knob 276 and second knob 278 attached respectively to the first and second end plates 246, 248 and seated slidably within respectively the first and second slots 280, 282 in the first and second side panels 212, 214.

A canopy vent hood of the present invention, particularly as shown and described herein, does not include any exhaust fan or filter. Instead, the present canopy vent hood increases the operational efficiencies of built-in exhaust fans and filters of over-the-range microwave ovens. A canopy vent hood of the present invention not only improves the containment and capture of heat, odor and vapor produced during cooking on a range top, it (a) improves the suction capacity of over-the-range microwave oven exhaust fans, (b) increases the face velocity of the ventilation air by reducing the open areas in the vicinity of the cooking surface, (c) improves capturing efficiencies of over-the-range microwave oven filters, (d) improves indoor air quality by capturing cooking odors, vapor and heat at the source, (e) reduces indoor air allergens caused by the spread of cooking fumes and subsequent remedial use of household cleaning agents, (f) reduces the spread of grease laden vapor and the deposit of grease particulates on kitchen cabinets, furniture, floor coverings, clothing and the like, and (g) improves indoor energy efficiency by alleviating or decreasing the need to open windows and doors to bring in fresh air. Further, the front panel of the nose member, when in its fully extended position, functions as a sanitary shield by reducing the contamination of food on the range top from coughing and sneezing. In addition, during light cooking and light usage of the range, a canopy vent hood of the present invention permits the built-in exhaust fan on an over-the-range microwave oven to be run at lower speeds, both saving energy and reducing the noise emanating from the fan. It is believed that the canopy vent hood of the present invention is eligible for Energy Star review and labels, which is a joint program of the U.S. Department of Energy (DOE) and the U.S. Environment Protection Agency (EPA). Further, the canopy vent hood of the present invention is, in preferred embodiments, designed and built to the standards of microwave manufacturers.

A canopy vent hood of the present invention can be used together with all standard over-the-range microwave ovens, regardless of manufacturer and regardless of whether they are new or older models, and regardless of whether they are preexisting installations or are being installed at the same time as the canopy vent hood. A canopy vent hood of the present invention does not need to be attached to the microwave oven itself and instead is preferably wall-mounted beneath the microwave oven. The benefits of a canopy vent hood of the present invention are realized regardless of whether the over-the-range microwave oven has circulating or non-circulating filter fan arrangements. Further there is no risk of overheating because over-the-range microwave ovens have a heat sensor which starts the fan if the fan is turned off (or not turned on) during cooking. The low height of a canopy vent hood of the present invention, and the side panels, makes it especially efficient in capturing fumes and heat and vapor from the range below it. Further, the side panels of a canopy vent hood of the present invention not only are more effective in capturing fumes and heat and vapor from the range below it than any device without side panels, the side panels also protect any adjacent wood or other susceptible cabinets from heat and fire.

A canopy vent hood of the present invention can be fabricated of standard materials such as stainless steel or galvanized steel with high-temperature resistant epoxy paint suitable for high-temperature appliances, styled and painted to match appliances as desired. As noted above, no filter or light or electrical lines are needed, because the microwave oven is already equipped with these items. With its low mounting, preferably flat panels and simplicity of components, the present canopy vent hood is easy to clean, install, and operate, and is easily packaged and manufactured.

A canopy vent hood of the present invention is not integrated with, or attached to, the microwave oven and therefore is far more versatile than any device requiring integration with, or attachment to, a microwave oven.

The present invention is a canopy vent hood comprising a nose member having a front panel, a first and second side panels each having a substantially straight-vertical front edge and together lying substantially within and determining a vertical plane. By substantially straight-vertical is meant a side edge that does not slant or curve significantly outwardly or inwardly, particularly if it juts out to receive part of nose member rather than freeing forward space by retracting the nose member to a position behind the sides. Not excluded from the terminology of substantially straight-vertical is an edge that is not perfectly smooth and even, and instead rough, bumpy or shallowly scalloped or the like that does not impair the advantages of the present invention. The nose member is positioned between and bridges the first and second side panels. The nose member translatable from a first position at which the front panel has an inclined orientation and is located substantially forward of the vertical plane, to a second position at which the front panel has a substantially horizontal orientation and is located at least partially forward of the vertical plane, to a third position at which the front panel has a substantially horizontal orientation is located substantially behind the vertical plane. The front panel in preferred embodiments has a surface area and is transparent about at least 50 percent of the surface area, and more preferably about at least 75, or 90, percent of the surface area. In further preferred embodiments, the nose member also has a first end plate and a second end plate which are supported respectively on the first and the second side panels, the first and second end plates being space apart and supporting the front panel.

The present invention is also a cooking station comprising a range top having a forward edge, a microwave oven mounted over the range top and a topless canopy vent hood mounted above the range top and beneath the microwave oven. The topless canopy hood vent of the cooking station, and of the present invention outside of the cooking station, is in embodiments a canopy vent hood having a first side panel, a second side panel and a triangulate-profiled nose element. The first and second side panels are spaced apart, and the nose element is translatable between a first position jutting out and downwardly over the range top from between the first and second side panels, to a second position jutting out over the range top from between the first and second side panels, to a third position completely retracted between the first and second side panels. In preferred embodiments, the first and second side panels each have a substantially straight-vertical first front edge, and these edges lie substantially within, and determine, a vertical plane. The nose member is substantially disposed forward of the vertical plane in the first position and substantially disposed behind the vertical plane in the third position. In further preferred embodiments, the nose element is a substantially see-through nose element. In further preferred embodiments, separately, the microwave bottom has a forward edge substantially aligned with the vertical plane, an exhaust fan located at the microwave bottom, and the topless canopy vent hood is disposed in close proximity to the microwave bottom.

The present invention is also a method of preparing food and venting fumes, heat, vapor and other emissions in the vicinity of a kitchen range below an over-the-range microwave oven. Such a method employs any embodiment of a cooking station, and any embodiment of a canopy vent hood, of the present invention. The steps of the method include translating the nose element to the first position and turning on the exhaust fan, preparing food on the range top whereby emissions are generated in the vicinity of the range top, allowing at least some of the emissions to be captured within the canopy vent hood, then concluding the generation of emissions in the vicinity of the range top, and then translating the nose element to the third position. In preferred embodiments the method also includes the steps, separately, of translating the nose element from the first position to the second position prior to the concluding of the generation of emissions in the vicinity of the range top, and then reaching out past the forward edge of the range top to the back region of the range top, and then withdrawing from the back region of the range top and then translating the nose element from the second position back to the first position.

It is noted here that the embodiments of the present invention illustrated herein are designed based on current industry standards by microwave oven manufacturers, although the present invention, particularly in broad embodiments, is not so limited.

While the foregoing written description of the invention enables one of ordinary skill in the art to make and use the invention, and to make and use what is presently considered the best mode of the invention, those of ordinary skill in the art will understand and appreciate the existence of variations, combinations and equivalents of the specific embodiments, methods and examples provided herein. The present invention should not be limited by the above described embodiments, methods and examples.

I claim:

1. A canopy vent hood comprising:
a nose member having a front panel;
a first side panel having a substantially straight-vertical first front edge; and
a second side panel having a substantially straight-vertical second front edge,
said first front edge and said second front edge lying substantially within and determining a vertical plane,
said nose member positioned between and bridging a first side panel and a second side panel, and
said nose member translatable from a first position at which said front panel has an inclined orientation and is located substantially forward of said vertical plane, to a second position at which said front panel has a substantially horizontal orientation and is located at least partially forward of said vertical plane, to a third position at which said front panel has a substantially horizontal orientation is located substantially behind said vertical plane.

2. A canopy vent hood according to claim 1 wherein said front panel has a surface area and is transparent about at least 50 percent of said surface area.

3. A canopy vent hood according to claim 1 wherein said front panel has a surface area and is transparent about at least 75 percent of said surface area.

4. A canopy vent hood according to claim 1 wherein said front panel has a surface area and is transparent about at least 90 percent of said surface area.

5. A canopy vent hood according to claim 1 wherein:
said nose member further has a first end plate and a second end plate,
said first end plate being supported on said first side panel,
said second end plate being supported on said second side panel,
said first and second end plates being space apart and supporting said front panel.

6. A cooking station comprising:
a range top having a forward edge;
a microwave oven mounted over said range top; and
a topless canopy vent hood mounted above said range top and beneath said microwave oven,
said canopy vent hood having a first side panel, a second side panel and a triangulate-profiled nose element,
said first and second side panels being spaced apart, and
said nose element being translatable between a first position jutting out and downwardly over said range top from between said first and second side panels, to a second position jutting out over said range top from between said first and second side panels, to a third position completely retracted between said first and second side panels.

7. A cooking station according to claim 6 wherein
said a first side panel has a substantially straight-vertical first front edge,
a second side panel has a substantially straight-vertical second front edge,
said first front edge and said second front edge lie substantially within and determining a vertical plane,
said nose member being substantially disposed forward of said vertical plane in said first position and substantially disposed behind said vertical plane in said third position.

8. A cooking station according to claim 6 wherein said nose element is a substantially see-through nose element.

9. A cooking station according to claim 6 wherein said microwave oven has a microwave bottom, and
said microwave bottom has a forward edge substantially aligned with said vertical plane.

10. A cooking station according to claim 6 wherein said microwave oven has a microwave bottom and an exhaust fan located at said microwave bottom, and
said topless canopy vent hood is disposed in close proximity to said microwave bottom.

11. A method of preparing food and venting fumes, heat, vapor and other emissions in the vicinity of a kitchen range below an over-the-range microwave oven employing a cooking station comprising a range top having a forward edge, a microwave oven mounted over said range top, said microwave oven having a microwave oven and an exhaust fan located at said microwave oven, and a topless canopy vent hood mounted above said range top and beneath said microwave oven and said exhaust fan having on/off modes, said canopy vent hood having a first side panel, a second side panel and a triangulate-profiled nose element, said first and second side panels being spaced apart, and said nose element being translatable between a first position jutting out and downwardly over said range top from between said first and second side panels, to a second position jutting out over said range top from between said first and second side panels, to a third position completely retracted between said first and second side panels, comprising the steps of:
translating said nose element to said first position and turning on said exhaust fan;
preparing food on said range top whereby emissions are generated in the vicinity of said range top;
allowing at least some of said emissions to be captured within said canopy vent hood;
then concluding said generation of emissions in the vicinity of said range top; and
then translating said nose element to said third position.

12. A method of preparing food according to claim 11, wherein said range top has a back region beneath said microwave oven, further including the steps of:
translating said nose element from said first position to said second position prior to said concluding of said generation of emissions in the vicinity of said range top; and
then reaching out past said forward edge of said range top to said back region of said range top.

13. A method of preparing food according to claim 11, wherein said range top has a back region beneath said microwave oven, further including the steps of:
translating said nose element from said first position to said second position prior to said concluding of said generation of emissions in the vicinity of said range top;
then reaching out past said forward edge of said range top to said back region of said range top;
then withdrawing from said back region of said range top; and
then translating said nose element from said second position back to said first position.
